(19) United States
(12) Patent Application Publication
(10) Pub. No.: US 2025/0051050 A1
(43) Pub. Date: Feb. 13, 2025

(54) AN APPARATUS FOR REMOVING A DEFECTIVE LABEL FROM A LABEL SUPPORT TAPE

(71) Applicant: Marchesini Group S.P.A., Pianoro (IT)

(72) Inventor: Simone NANNETTI, GRIZZANA MORANDI (IT)

(21) Appl. No.: 18/718,672

(22) PCT Filed: Dec. 19, 2022
(86) PCT No.: PCT/IB2022/062444

§ 371 Date: Jun. 11, 2024

(30) Foreign Application Priority Data
Dec. 23, 2021 (IT) 102021000032396

(51) Int. Cl. B65C 9/40; B65C 9/18

(52) U.S. Cl. CPC B65C 9/40; B65C 9/1865; B65C 2009/404

(57) ABSTRACT

An apparatus for removing a defective label from a label support tape comprises a return member arranged between a first return roller and a second return roller. The return member comprises a contact portion having a first contact part and a second contact part. The first contact part is shaped as a portion of cylinder arranged eccentric with respect to the rotation axis of the return member and conformed so that when the return member is rotated to arrange a part of the portion of cylindrical surface in contact with the support tape, the labels remain on the support tape. The second contact part comprises two surfaces converging to form a cusp, conformed so that when the return member is activated in rotation to arrange the cusp in contact with the support tape, the non-compliant labels present on the support tape detach from the support tape.

### DESCRIPTION OF THE INVENTION

### Field of the Invention

The present invention relates to the technical sector relating to the labelling of products by application of labels which are detached (or “peeled”) from a support tape to which the labels are attached by a glue material.

### DESCRIPTION OF THE PRIOR ART

There is a known need to associate, to certain types of products, such as for example pharmaceutical products, information relating to the respective characteristics and/or composition of a batch of production, images and/or logos, compliance information, etc.

A technique utilised is to supply the information on a label then to be applied to the product.

Usually for this purpose, a support tape is used, for example made of a plastic material or laminated paper, on which the labels are attached by means of a glue material.

The support tape is unwound from a relative reel and on them are printed information relating to the corresponding products on which the labels are to be applied.

Once the information has been printed on the labels relating to the products on which they are then to be applied, the support tape is fed by suitable unwinding rollers, and according to a prefixed extension and unwinding path to the area in which the labels are to be detached from the support tape and applied on the products.

Usually, in order to carry out the detachment of the labels from the support tape, the tape is subjected to sharp changes of direction with respect to the extension and unwinding path thereof, in such a way that the labels detach from the support tape.

At the area in which the support tape is subjected to these sharp changes of the unwinding direction there are transfer means (for example rollers or drums) in order to transfer the label detaching from the support tape onto a surface of the product on which the label is to be applied.

An issue that can occur consists in the fact that some labels, following the printing step, can bear information that is not precise or correct, and is therefore defective and unsuitable to be applied on a corresponding product.

In these cases, it is necessary to prevent the defective label from being applied on the product.

A first known solution for obviating this drawback is described in document U.S. Pat. No. 5,405,482, of which some drawings are contained in FIGS. 1 and 2.

This document contains a description of a labelling apparatus (E) for application of labels on relative products (P) with rejection of the defective labels.

The support tape (N), on which the labels are present, is unwound from a first reel (N1) so as to be rewound on a second reel (N2).

Between the two reels, along the unwinding path of the support tape (N), there is a plate (B) having a profiled end in the shape of a sort of wedge which is arranged to abut the support tape (N) and switch the support tape (N) sharply, to form a sort of cusp, so that all the labels present on the support tape (N), on the passage thereof at the cusp, detach from the support tape (N) and are collected by a rotary aspirating drum (T).

The rotary aspirating drum (T) then transfers the labels, with the part on which the glue material is present, to products (P) advancing along a conveyor (Z), so as to apply the labels on the products (P).

The labelling apparatus (E) described in the present document also comprises detection means (S) which are arranged in a position upstream with respect to the point in which the support tape (N) is subjected to the sharp change of direction and which are configured in such a way as to detect the information present on the labels and compare it with reference information to verify the intactness of the labels.

The labelling apparatus (E) also comprises rejection means (D) which are arranged facing the rotary aspirating drum (T) and are activatable to detach, from the drum (T), those labels (F) which have been recognised by the detection means (S) as defective, and which are therefore not suitable to be applied to the products.

The rejection means (D) comprise a double-acting pneumatic piston (D1) which bears, at an end thereof, a roller (D2).

When the detection means (S) identify a defective label (F) present on the conveyor belt (N), they send a corresponding signal to the control unit of the labelling apparatus (E) which will activate the pneumatic piston (D1) when the defective label (F), once detached from the support tape (N) and collected by the rotary aspirating drum (T), will pass at the position at which the pneumatic piston (D1) is situated.

The pneumatic piston (D1) pushes the roller (D2) towards the aspirating drum to abut the defective label (F) which adheres, owing to the presence of the glue material, to the roller (D2), and then the pneumatic piston (D1) will retract the roller (D2) so as to remove the defective label (F) from the aspirating drum (T) (FIG. 2).

An apparatus like this will however have various drawbacks.

Firstly, all the labels, i.e. both the compliant and the defective (and therefore not suitable to be applied on a respective product), are detached from the support tape, and it is not impossible that, for any reason, for example due to a malfunctioning of the pneumatic piston, a defective label might in any case be applied to a product.

Further, the unwinding velocity of the support tape, and therefore the frequency of application of the labels on the products, will not be able to reach high values, as it is necessary to leave the time for the pneumatic piston to be activated in its outward stroke and return stroke for each label that has been recognised as non-compliant.

Another known solution, aimed at preventing any defective labels from being in any case applied on respective products, is described in document US2006/0144521 of which some drawings are provided in FIGS. 3 and 4.

The present document describes a labelling apparatus (G) which includes, at the label application area on respective products, detaching from the support tape only the compliant labels suitable to application on the products, while the defective and non-compliant labels are left on the support tape.

The apparatus (G) described in this document comprises an unwinding unit (G1) of the support tape (M) of the labels comprising a series of unwinding rollers (M1, M10, M11) of the support tape (M) which are arranged in such a way as to unwind the support tape (M) along an extension and unwinding path such as to near it to products (P) which are moved according to a circular path.

In particular, the unwinding unit (G1) comprises a head roller (M10) arranged facing the circular path of movement of the products (P).

The apparatus (G) has a peeling plate (R) of the labels which is arranged in proximity of the head roller (M10) and is activatable between an advanced position (R1) with respect to the head roller (M10), in which it pushes on the support tape (M) in such a way as to detach it from the head roller (M10) and subject it to a sharp change of direction, so as to detach a label, and a retracted position (R2), in which it is retracted with respect to the head roller (M10) and detached from the support tape (M) leaving the support tape (M) in complete contact with, and wound on, the head roller (M10), in such a way that a label remains attached to the support tape (M10).

When, on the support tape (M) that the unwinding unit (M) is to operate on, a compliant label (E1), having correct information, is identified, and thus being suitable for application on a corresponding product, the peeling plate (R) is brought into the advanced position (R1) so that when the compliant label (E1) reaches the head roller (M10) it is detached from the support tape (M), by effect of the change of direction to which the support tape (M) is subjected due to the advanced position of the peeling plate (R) (FIG. 3), and by means of a drum (W) it is then transferred and applied on a product (P) in movement along the circular path.

Instead, when on the support tape (M) a non-compliant label (E2) is identified having incorrect information, and thus being unsuitable for application on a corresponding product, the peeling plate (R) is brought into the retracted position (R2) in such a way that when the non-compliant label (E2) reaches the head roller (M10) the support tape (M) can normally wind about the head roller (M10) without the non-compliant label (E2) being able to detach from the support tape (M) (FIG. 4), and thus no label will be applied on the product (P*) which in the meantime transits at the drum (W).

The solution described in this second document also has drawbacks.

The support tape (M) is subjected to continuous tensioning stresses due to the activation of the peeling plate, between the advanced position and the retracted position, which continuously changes the extension and unwinding path thereof, especially at the label application area, i.e. at the head roller of the unwinding unit.

In fact, when the peeling plate (R) is brought into the retracted position (R2) (FIG. 4), so as to keep the support tape (M) which is to be wound about the head roller (M10) tensioned, it is necessary to use a compensation and adjustment system of the position of the winding roller (M11) downstream of the head roller (M10), which is constituted by a roller (C1) which is activated to follow a cam profile (C2) in such a way as to displace the position of the winding roller (M11) downstream of the head roller (M10).

This can have, as a consequence, an incorrect positioning of the compliant labels with respect to the position of the products on which they are to be applied, with the consequent risk of applying the labels neither in the necessary position nor in the requested times.

### SUMMARY OF THE INVENTION

The aim of the present invention is therefore to provide an apparatus for removing a defective label from a label support tape able to obviate the drawbacks present in the prior-art apparatuses described in the foregoing.

In particular, an aim of the present invention is to provide an apparatus for removing a defective label from a support belt without altering the extension and unwinding path of the support belt, on which only the labels that are compliant and therefore suitable to be subsequently applied to corresponding products will remain.

The above aims are attained with an apparatus for removing a defective label from a label support tape according to the contents of the claims.

### BRIEF DESCRIPTION OF THE DRAWINGS

The characteristics of a preferred, but not exclusive, embodiment of the apparatus for removing a defective label from a label support tape of the present invention will be described in the following with reference to the appended tables of drawings, in which:

FIGS. 1 and 2, already mentioned in the foregoing, illustrate the characteristics of the labelling apparatus of the prior-art described in document U.S. Pat. No. 5,405,482;

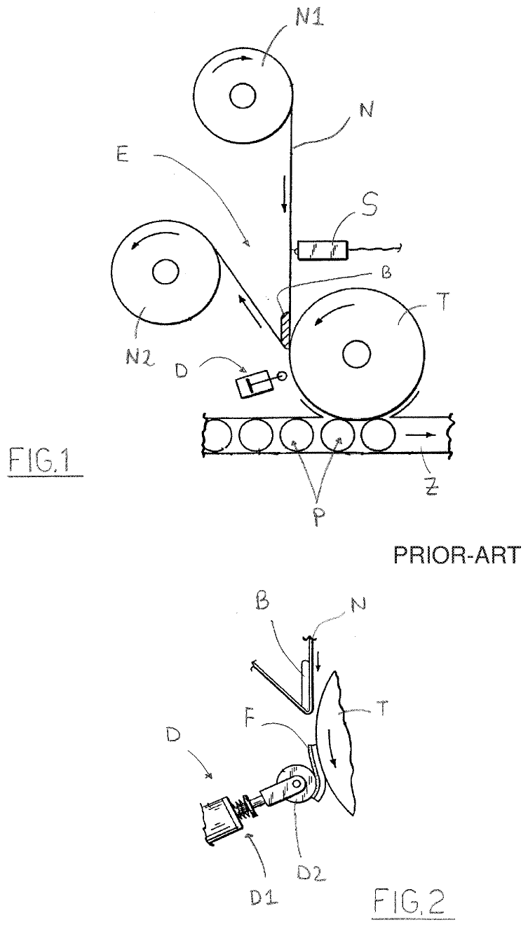

FIGS. 3 and 4, also mentioned in the foregoing, illustrate, according to respective schematic views, the characteristics of another labelling apparatus of the prior-art, described in document US2006/0144521;

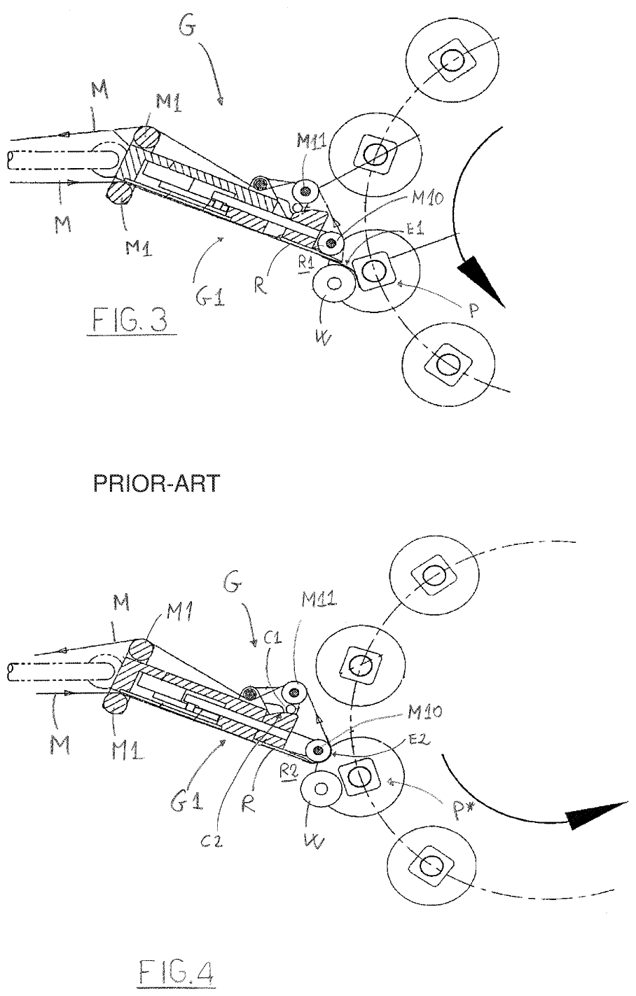

FIG. 5A illustrates, in a schematic front view, partially sectioned, the apparatus of the invention in a first operating configuration in which the support tape of the labels is unwound and fed in a predetermined extension and unwinding path and with the labels identified as compliant remaining on the support tape;

FIG. 5B illustrates, in larger scale and in a perspective view, some relevant components of the apparatus of the invention in the first operating configuration of FIG. 5A;

FIG. 5C illustrates the detail denoted by H of FIG. 5A in larger scale;

FIG. 6A illustrates, in a schematic front view, partially sectioned, the apparatus of the invention in a second operating configuration in which the support tape of the labels is unwound and fed also in a predetermined extension and unwinding path but in which a label identified as non-compliant is detached from the support tape;

FIG. 6B illustrates, in larger scale and in a perspective view, some relevant components of the apparatus of the invention in the second operating configuration of FIG. 6A but in which a label identified as non-compliant is detached from the support tape.

FIG. 6C is a larger-scale view of the detail denoted by letter K of FIG. 6A.

### DESCRIPTION OF PREFERRED EMBODIMENTS

With reference to FIGS. from 5A to 6C, reference numeral (100) denotes the apparatus for removing a defective label (EW) from a label support tape (10), object of the present invention, in its entirety.

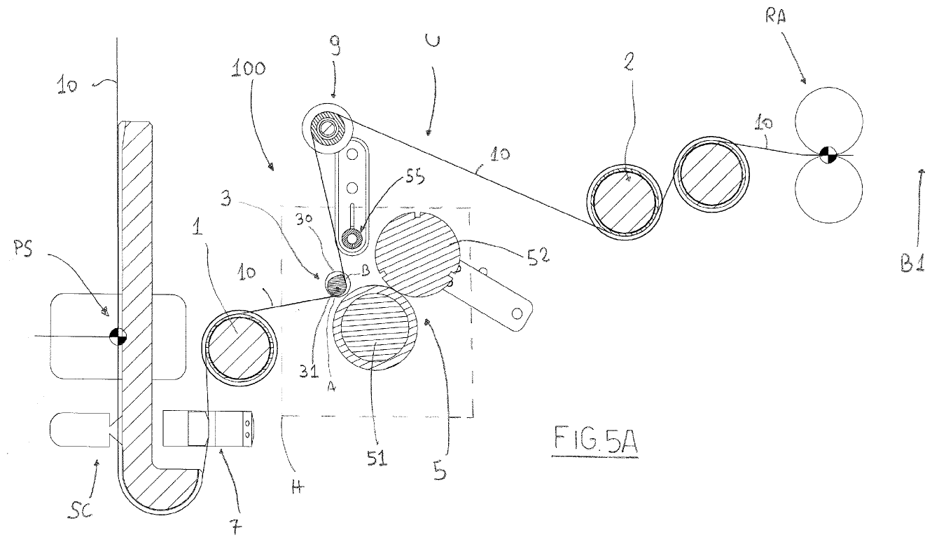

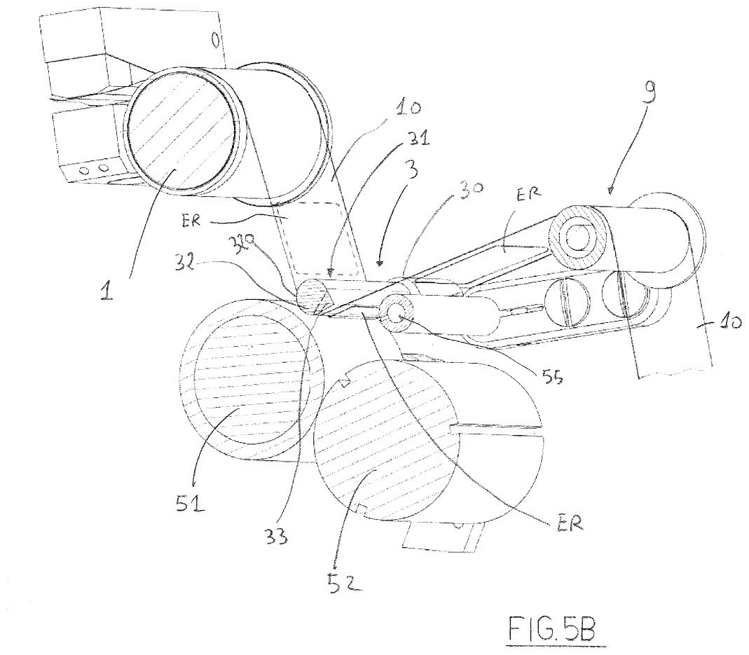

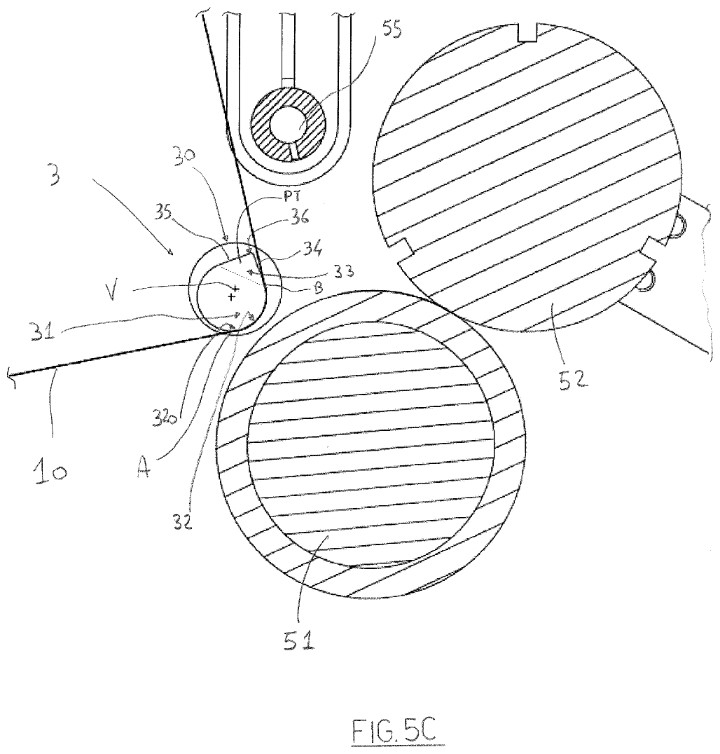

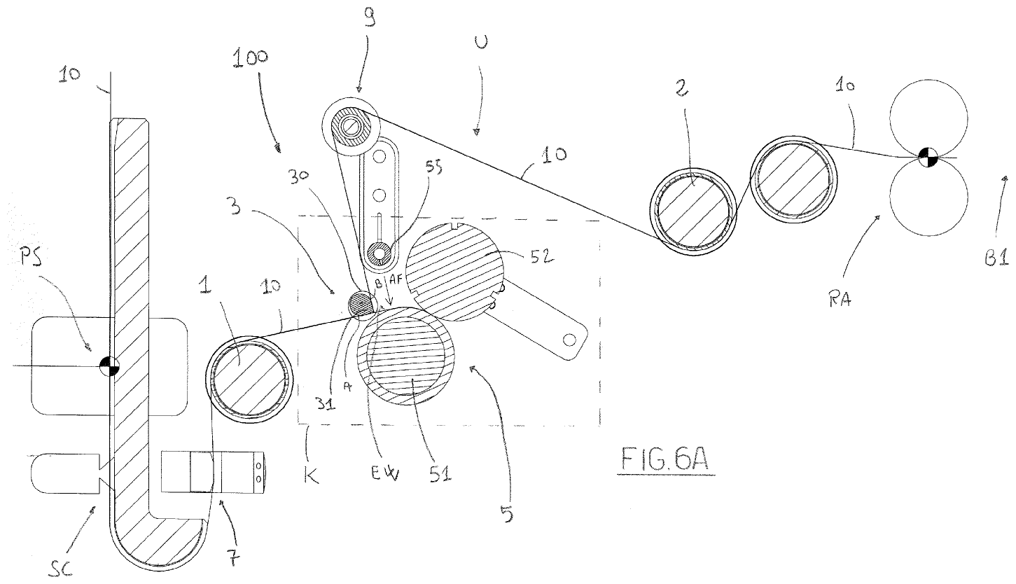

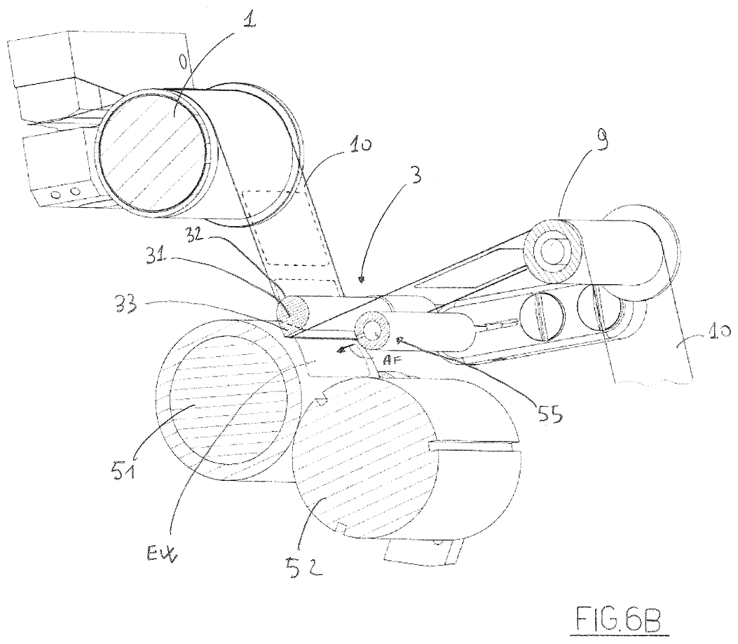

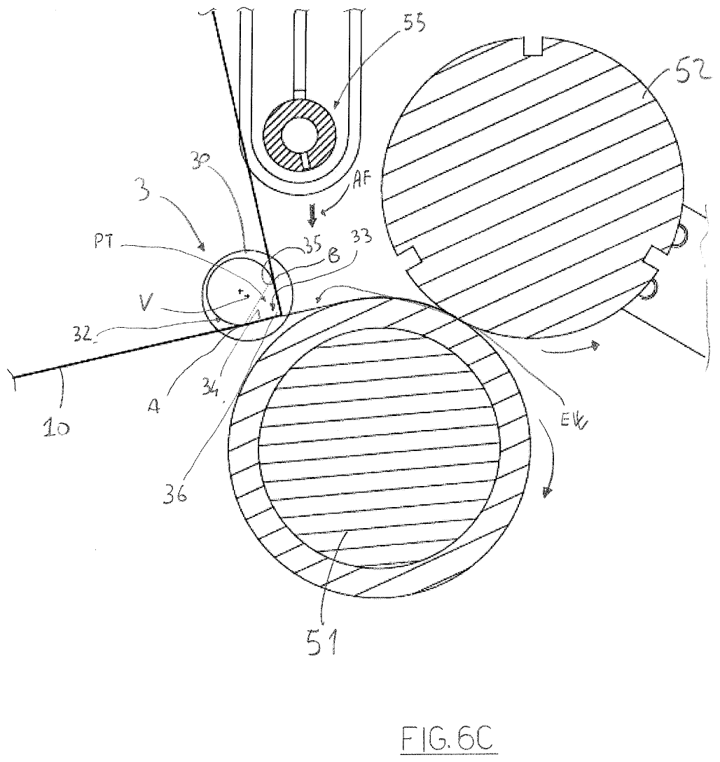

The apparatus (100) comprises a first return roller (1) of a label support tape (10), which is arranged and configured so as to receive a label support tape (10) coming from a printing station (PS) configured so as to print information on the labels present on the support tape (10) and from a checking and control station (SC) arranged downstream of the printing station (PS), configured to verify the compliance of the information printed on the labels;
and at least a second return roller (2) of the support tape (10) arranged downstream with respect to the first return roller (1) so as to receive the support tape (10) coming from the first return roller (1) and arranged and configured so as to direct the support tape (10) towards advancement rollers (RA) of the support tape (10) to a label application station (B1) (the station being schematically denoted by only an arrow in FIGS. 5A and 6A, as not being an object of the invention).

The apparatus (100) further comprises at least a return member (3) of the support tape (10) arranged between the first return roller (1) and the second return roller (2); the at least a return member (3) is conformed in such a way as to comprise a main body (30) and a contact portion (31), which is borne by the main body (30), for contact with the support tape (10) in such a way that the support tape (10) winds about the contact portion (31) and has a predetermined unwinding path (U) (see again for example FIGS. 5A and 6A), between the first return roller (1) and the second return roller (2), and thus between the printing station (PS) and the advancement rollers (RA) of the support tape (10) towards the label application station (B1).

The position of the first return roller (1) and the position of the second return roller (2) illustrated in the figures are purely indicative and therefore not exclusive, as there can be various arrangements; also the unwinding path (U) of the support tape (10) can be different from what is illustrated, as can the location of the printing station (PS) and the position of the advancement rollers (RA) of the support tape (10).

The peculiarities of the apparatus (100) of the present invention are as follows.

The main body (30) of the at least a return member (3) is activatable in rotation about a respective rotation axis (V) and the contact portion (31) of the at least a return member (3) is shaped in such a way as to comprise a first contact part (32), for the contact with the support tape (10), and a second contact part (33), for the contact with the support tape (10).

In detail (see for example FIGS. 5B, 5C, 6B, 6C):
the first contact part (32) is conformed as a portion of cylinder having a portion of cylindrical surface (320), for the contact and winding of the support tape (10), which is arranged eccentric with respect to the rotation axis (V) of the main body (30), wherein the portion of cylindrical surface (320) is conformed in such a way that the labels (ER) present on the support tape (10) remain on the support tape (10) when the support tape (10) winds about a part of the portion of cylindrical surface (320);
the second contact part (33), arranged on the opposite side to the first contact part (32) with respect to the rotation axis (V) of the main body (30), is conformed in such a way as to comprise two surfaces (34, 35) converging with respect to one another in such a way as to form a cusp (36), for the contact and winding of the support tape (10) (EW) wherein the cusp (36) is conformed in such a way that the labels present on the support tape (10) detach from the support tape (10) when the support tape (10) winds on the two converging surfaces (34, 35) of the cusp (36).

In particular, according to the information obtained from the passage of the support tape (10) through the checking and control station (SC), i.e. according to whether there are labels (ER) on the support tape (10) which are considered to be compliant and labels (EW) considered to be non-compliant, the main body (30) of the return member (3) is activatable in rotation about the respective rotation axis (V) in a first rotation direction in order to arrange a part of the portion of cylindrical surface (320) of the first contact part (32) in contact with the support tape (10) so as to leave on the support tape (10) the labels recognised as compliant by the checking and control station (SC) (situation illustrated in FIGS. 5A, 5B, 5C), while the main body (30) of the return member (3) is instead activatable in rotation about the respective rotation axis (V) in a second rotation direction so as to arrange the two converging surfaces (34, 35) of the cusp (36) of the second contact part (33) in contact with the support tape (10) so as to detach a label (EW) from the support tape (10) which label has been recognised as non-compliant in the passage thereof from the checking and control station (SC) (situation illustrated in FIGS. 6A, 6B, 6C).

In this way, on the support tape (10), once having passed the return member (3), there will be only compliant labels, while the non-compliant labels will have been detached from the support tape (10).

Further, the portion of cylindrical surface (320) of the first contact part (32) is arranged eccentric with respect to the rotation axis (V) of the main body (30) and the first contact part (32) and the second contact part (33) of the contact portion (31) are configured and conformed in such a way that, both when the main body (30) is rotated about the respective rotation axis (V) in order to arrange a part of the portion of cylindrical surface (320) of the first contact part (32) in contact with the support tape (10) and when the main body (30) is rotated about the respective rotation axis (V) so as to arrange the two surfaces (34, 35) that are convergent to one another to form the cusp (36) of the second contact part (33) in contact with the support tape (10), the support tape (10) winds about a part of the portion of cylindrical surface (320) of the first contact part (32) of the contact portion (31) or on the two converging surfaces (34, 35) of the cusp (36) of the second contact part (33) always between a first contact point (A) and a second contact point (B).

In other words, the length of the support tape (10) between the first contact point (A) and the second contact point (B) with the contact portion (31) of the return member (3) remains unaltered, i.e. always the same, both when the main body (30) is rotated about the respective rotation axis (V) in order to arrange a part of the portion of cylindrical surface (320) of the first contact part (32) in contact with the support tape (10) and when the main body (30) is rotated about the respective rotation axis (V) so as to arrange the two surfaces (34, 35) that are convergent to one another to form the cusp (36) of the second contact part (33) in contact with the support tape (10).

Therefore, consequently, also the length of the support tape (10) between the printing station (PS) and the application station (B1) of the compliant labels (ER) remains the same, and therefore so does the relative unwinding path, without undesired stretching or loosening.

The further enables avoiding the use of any compensating devices of the winding, and therefore tensioning, of the support tape, as instead occurs in the apparatus described by document US2006/0144521, briefly described in the foregoing.

Therefore, owning these special configurations and conformations of the first contact part (32) (shape and eccentricity of the portion of cylindrical surface with respect to the rotation axis of the main body) and of the second contact part (33) (cusp shape with two convergent surfaces) of the contact portion (31) of the return member (3), in the apparatus of the invention it is therefore possible to remove from the support tape (10) only the non-compliant labels (EW) in conjunction with the passage of the support tape (10) at the return member (3), and, at the same time maintain unaltered the predetermined unwinding path (U) of the support tape (10) between the printing station (PS) and the advancement rollers (RA) of the support tape (10) towards the label application station.

This enables always keeping the support tape (10) correctly positioned and stretched, and therefore also the compliant labels (ER) present thereon, in the unwinding path thereof from the printing station (PS) to the application station (B1) of the compliant labels (ER) on respective products.

The apparatus of the invention is thus able to remove, from the support tape, only the labels considered non-compliant following the passage of the support tape through the checking and control station (SC) and directing the support tape containing only compliant labels, and correctly positioned on the same support tape, to the label application station, thus obviating the drawbacks present in the prior-art as previously demonstrated.

Other and further preferred and advantageous aspects of the invention are as described in the following.

The second contact part (33) of the contact portion (31) is preferably conformed in such a way as to comprise two flat surfaces (34, 35) which are convergent to one another in such a way as to form a cusp (36).

In particular, in the preferred embodiment illustrated in the figures, the second contact part (33) of the contact portion (31) is conformed in such a way as to form a triangular prism (PT) connected to the portion of cylindrical surface (320) of the first contact part (32) of the contact portion (31).

A further advantageous aspect of the invention relates to the fact that the apparatus (100) comprises guide means (5) for guiding the non-compliant label (EW) which is detached from the support tape (10), when the main body (30) of the return member (3) is activated in rotation about the respective rotation axis (V) so as to arrange the two converging surfaces (34, 35) of the cusp (36) of the second contact part (33) in contact with the support tape (10), towards an accumulation and rejection station.

In the preferred embodiment illustrated in the figures, the guide means (5) are preferably made in such a way as also to comprise a drum (51) having a rotation axis and arranged in a position facing the contact portion (31) of the return member (3) and an accumulation roller (52) of non-compliant labels, which is mounted idle about a respective rotation axis and arranged in contact with the drum (51).

The drum (51), when the main body (30) of the return member (3) is activated in rotation about the respective rotation axis (V) so as to arrange the two converging surfaces (34, 35) of the cusp (36) of the second contact part (33) in contact with the support tape (10) so as to detach a non-compliant label (EW) from the support tape (10), is activatable in rotation about the respective rotation axis so as to abut at least an external part of the non-compliant label (EW) detached from the support tape (10) and to guide the non-compliant label (EW) towards the accumulation roller (52) in such a way that the part of the non-compliant label (EW) on which glue material is present abuts the accumulation roller (52) and the non-compliant label (EW) attaches to the accumulation roller (52).

The guide means (5) can advantageously comprise an emitting element (55) of a puff of air (AF) (see for example FIGS. 6A, 6B and 6C) which is arranged and configured, when the main body (30) of the return member (3) is activated in rotation about the respective rotation axis (V) so as to arrange the two converging surfaces (34, 35) of the cusp (36) of the second contact part (33) in contact with the support tape (10) for detachment of a non-compliant label (EW) from the support tape (10), in such a way as to direct a puff of air towards at least a part of the non-compliant label (EW) detached from the support tape (10) in order to maintain the non-compliant label (EW) in adherence to the drum (51) during the activation in rotation of the drum (51) and thus facilitate the transfer of the non-compliant label (EW) from the drum (51) to the accumulation roller (52).

In a further preferred aspect, the apparatus (100) can comprise a detection and control unit (7) of the position of the labels on the support tape (10) arranged between the checking and control station (SC) and the first return roller (1).

The detection and control unit (7) is configured and set up to detect the position of the labels considered compliant and the position of the labels considered non-compliant so that the apparatus can activate the rotation of the return member and thus correctly position the first contact part of the contact portion or the second contact part of the contact portion according to whether a compliant label is reaching the return member which compliant label, therefore, must remain on the support tape, or a non-compliant label which, therefore, must be detached from the support tape.

The apparatus (100) can also comprise at least a second return member (9) between the first return roller (1) and the second return roller (2) for defining the predetermined unwinding path (U) of the support tape (10).

The at least a second return member (9) can be arranged between the first return member (3) and the second return roller (2) or between the first return roller (1) and the first return member (3).

1. An apparatus for removing a defective label from a label support tape, comprising:
a first return roller of a label support tape, arranged and configured so as to receive a label support tape coming from a printing station of information on the labels present on the support tape and from a checking and control station of the compliance of the information printed on the labels;
at least a second return roller of the support tape arranged downstream with respect to the first return roller so as to receive the support tape coming from the first return roller and arranged and configured so as to direct the support tape towards advancement rollers of the support tape to a label application station;
at least a return member of the support tape arranged between the first return roller and the second return roller, wherein the at least a return member is conformed in such a way as to comprise a main body and a contact portion, borne by the main body, for contact with the support tape in such a way that the support tape winds about the contact portion and has a predetermined unwinding path between the first return roller and the second return roller, and thus between the printing station and the advancement rollers of the support tape towards the label application station;
characterised in that the main body of the at least a return member is activatable in rotation about a respective rotation axis and in that the contact portion of the at least a return member is shaped in such a way as:
to comprise a first contact part, which is conformed as a portion of cylinder having a portion of cylindrical surface, for the contact and winding of the support tape, which is arranged eccentric with respect to the rotation axis of the main body, wherein the portion of cylindrical surface is conformed in such a way that the labels present on the support tape remain on the support tape when the support tape winds about a part of the portion of cylindrical surface;
and comprises a second contact part, arranged on the opposite side to the first contact part with respect to the rotation axis of the main body, which is conformed in such a way as to comprise two surfaces converging with respect to one another in such a way as to form a cusp, for the contact and winding of the support tape, wherein the cusp is conformed in such a way that the labels present on the support tape detach from the support tape when the support tape winds on the two converging surfaces of the cusp;
wherein the main body is activatable in rotation about the respective rotation axis in a first rotation direction in order to arrange a part of the portion of cylindrical surface of the first contact part in contact with the support tape so as to leave on the support tape the labels recognised as compliant by the checking and control station, and wherein the main body is instead activatable in rotation about the respective rotation axis in a second rotation direction so as to arrange the two converging surfaces of the cusp of the second contact part in contact with the support tape so as to detach a label from the support tape which label has been recognised as non-compliant in the passage thereof from the checking and control station;
with the portion of cylindrical surface of the first contact part being arranged eccentric with respect to the rotation axis of the main body and with the first contact part and the second contact part of the contact portion being configured and conformed in such a way that, both when the main body is rotated about the respective rotation axis in order to arrange a part of the portion of cylindrical surface of the first contact part in contact with the support tape and when the main body is rotated about the respective rotation axis so as to arrange the two surfaces that are convergent to one another to form the cusp of the second contact part in contact with the support tape, the support tape winds about a part of the portion of cylindrical surface of the first contact part of the contact portion or on the two converging surfaces of the cusp of the second contact part always between a first contact point and a second contact point in such a way that the support tape maintains unaltered its predetermined unwinding path between the printing station and the advancement rollers of the support tape towards the label application station.

2. The apparatus as claimed in claim 1, wherein
the second contact part of the contact portion is conformed in such a way as to comprise two flat surfaces which are convergent to one another in such a way as to form the cusp.

3. The apparatus as claimed in claim 2, wherein the second contact part of the contact portion is conformed in such a way as to form a triangular prism connected to the portion of cylindrical surface of the first contact part of the contact portion.

4. The apparatus as claimed in claim 1, comprising guide means for guiding the non-compliant label which is detached from the support tape, when the main body of the return member is activated in rotation about the respective rotation axis so as to arrange the two converging surfaces of the cusp of the second contact part in contact with the support tape, towards an accumulation and rejection station.

5. The apparatus as claimed in claim 4, wherein the guide means comprise a drum having a rotation axis and arranged in a position facing the contact portion of the return member and an accumulation roller of non-compliant labels, which is mounted idle about a respective rotation axis and arranged in contact with the drum, wherein the drum, when the main body of the return member is activated in rotation about the respective rotation axis so as to arrange the two converging surfaces of the cusp of the second contact part in contact with the support tape so as to detach a non-compliant label from the support tape, is activatable in rotation about the respective rotation axis so as to abut at least an external part of the non-compliant label detached from the support tape and to guide the non-compliant label towards the accumulation roller in such a way that the part of the non-compliant label on which glue material is present abuts the accumulation roller and the non-compliant label attaches to the accumulation roller.

6. The apparatus as claimed in claim 5, wherein the guide means comprise an emitting element of a puff of air which is arranged and configured, when the main body of the return member is activated in rotation about the respective rotation axis so as to arrange the two converging surfaces of the cusp of the second contact part in contact with the support tape for detachment of a non-compliant label from the support tape, in such a way as to direct a puff of air towards at least a part of the non-compliant label detached from the support tape in order to maintain the non-compliant label in adherence to the drum during the activation in rotation of the drum and thus facilitate the transfer of the non-compliant label from the drum to the accumulation roller.

7. The apparatus as claimed in claim 1, comprising a detection and control unit of the position of the labels on the support tape arranged between the checking and control station and the first return roller.

8. The apparatus as claimed in claim 1, comprising at least a second return member between the first return roller and the second return roller for defining the predetermined unwinding path of the support tape.

9. The apparatus as claimed in claim 8, wherein the at least a second return member is arranged between the first return member and the second return roller or between the first return roller and the first return member.

10. An apparatus for removing a defective label from a label support tape, comprising:
a first return roller of a label support tape, arranged and configured so as to receive a label support tape coming from a printing station of information on the labels present on the support tape and from a checking and control station of the compliance of the information printed on the labels;
at least a second return roller of the support tape arranged downstream with respect to the first return roller so as to receive the support tape coming from the first return roller and arranged and configured so as to direct the support tape towards advancement rollers of the support tape to a label application station;
at least a return member of the support tape arranged between the first return roller and the second return roller, wherein the at least a return member is conformed in such a way as to comprise a main body and a contact portion, borne by the main body, for contact with the support tape in such a way that the support tape winds about the contact portion and has a predetermined unwinding path between the first return roller and the second return roller, and thus between the printing station and the advancement rollers of the support tape towards the label application station;
characterised in that the main body of the at least a return member is activatable in rotation about a respective rotation axis and in that the contact portion of the at least a return member is shaped in such a way as:
to comprise a first contact part, which is conformed as a portion of cylinder having a portion of cylindrical surface, for the contact and winding of the support tape, which is arranged eccentric with respect to the rotation axis of the main body, wherein the portion of cylindrical surface is conformed in such a way that the labels present on the support tape remain on the support tape when the support tape winds about a part of the portion of cylindrical surface;
and comprises a second contact part, arranged on the opposite side to the first contact part with respect to the rotation axis of the main body, which is conformed in such a way as to comprise two surfaces converging with respect to one another in such a way as to form a cusp, for the contact and winding of the support tape, wherein the cusp is conformed in such a way that the labels present on the support tape detach from the support tape when the support tape winds on the two converging surfaces of the cusp; the second contact part of the contact portion comprises two flat surfaces which are convergent to one another in such a way as to form the cusp,
wherein the main body is activatable in rotation about the respective rotation axis in a first rotation direction in order to arrange a part of the portion of cylindrical surface of the first contact part in contact with the support tape so as to leave on the support tape the labels recognised as compliant by the checking and control station, and wherein the main body is instead activatable in rotation about the respective rotation axis in a second rotation direction so as to arrange the two converging surfaces of the cusp of the second contact part in contact with the support tape so as to detach a label from the support tape which label has been recognised as non-compliant in the passage thereof from the checking and control station;
with the portion of cylindrical surface of the first contact part being arranged eccentric with respect to the rotation axis of the main body and with the first contact part and the second contact part of the contact portion being configured and conformed in such a way that, both when the main body is rotated about the respective rotation axis in order to arrange a part of the portion of cylindrical surface of the first contact part in contact with the support tape and when the main body is rotated about the respective rotation axis so as to arrange the two surfaces that are convergent to one another to form the cusp of the second contact part in contact with the support tape, the support tape winds about a part of the portion of cylindrical surface of the first contact part of the contact portion or on the two converging surfaces of the cusp of the second contact part always between a first contact point and a second contact point in such a way that the support tape maintains unaltered its predetermined unwinding path between the printing station and the advancement rollers of the support tape towards the label application station; and
guide means for guiding the non-compliant label detached from the support tape when the main body of the return member is activated in rotation about the respective rotation axis so as to arrange the two converging surfaces of the cusp of the second contact part in contact with the support tape, towards an accumulation and rejection station.

11. The apparatus as claimed in claim 10, wherein the second contact part of the contact portion is conformed in such a way as to form a triangular prism connected to the portion of cylindrical surface of the first contact part of the contact portion.

12. The apparatus as claimed in claim 10, wherein the guide means comprise a drum having a rotation axis and arranged in a position facing the contact portion of the return member and an accumulation roller of non-compliant labels, which is mounted idle about a respective rotation axis and arranged in contact with the drum, wherein the drum, when the main body of the return member is activated in rotation about the respective rotation axis so as to arrange the two converging surfaces of the cusp of the second contact part in contact with the support tape so as to detach a non-compliant label from the support tape, is activatable in rotation about the respective rotation axis so as to abut at least an external part of the non-compliant label detached from the support tape and to guide the non-compliant label towards the accumulation roller in such a way that the part of the non-compliant label on which glue material is present abuts the accumulation roller and the non-compliant label attaches to the accumulation roller.

13. The apparatus as claimed in claim 12, wherein the guide means comprise an emitting element of a puff of air which is arranged and configured, when the main body of the return member is activated in rotation about the respective rotation axis so as to arrange the two converging surfaces of the cusp of the second contact part in contact with the support tape for detachment of a non-compliant label from the support tape, in such a way as to direct a puff of air towards at least a part of the non-compliant label detached from the support tape in order to maintain the non-compliant label in adherence to the drum during the activation in rotation of the drum and thus facilitate the transfer of the non-compliant label from the drum to the accumulation roller.

14. The apparatus as claimed in claim 10, comprising a detection and control unit of the position of the labels on the support tape arranged between the checking and control station and the first return roller.

15. The apparatus as claimed in claim 10, comprising at least a second return member between the first return roller and the second return roller for defining the predetermined unwinding path of the support tape.

16. The apparatus as claimed in claim 15, wherein the at least a second return member is arranged between the first return member and the second return roller or between the first return roller and the first return member.

17. An apparatus for removing a defective label from a label support tape, comprising:
a first return roller of a label support tape, arranged and configured so as to receive a label support tape coming from a printing station of information on the labels present on the support tape and from a checking and control station of the compliance of the information printed on the labels;
at least a second return roller of the support tape arranged downstream with respect to the first return roller so as to receive the support tape coming from the first return roller and arranged and configured so as to direct the support tape towards advancement rollers of the support tape to a label application station;
at least a return member of the support tape arranged between the first return roller and the second return roller, wherein the at least a return member is conformed in such a way as to comprise a main body and a contact portion, borne by the main body, for contact with the support tape in such a way that the support tape winds about the contact portion and has a predetermined unwinding path between the first return roller and the second return roller, and thus between the printing station and the advancement rollers of the support tape towards the label application station;
characterised in that the main body of the at least a return member is activatable in rotation about a respective rotation axis and in that the contact portion of the at least a return member is shaped in such a way as:
to comprise a first contact part, which is conformed as a portion of cylinder having a portion of cylindrical surface, for the contact and winding of the support tape, which is arranged eccentric with respect to the rotation axis of the main body, wherein the portion of cylindrical surface is conformed in such a way that the labels present on the support tape remain on the support tape when the support tape winds about a part of the portion of cylindrical surface;
and comprises a second contact part, arranged on the opposite side to the first contact part with respect to the rotation axis of the main body, which is conformed in such a way as to comprise two surfaces converging with respect to one another in such a way as to form a cusp, for the contact and winding of the support tape, wherein the cusp is conformed in such a way that the labels present on the support tape detach from the support tape when the support tape winds on the two converging surfaces of the cusp;
wherein the main body is activatable in rotation about the respective rotation axis in a first rotation direction in order to arrange a part of the portion of cylindrical surface of the first contact part in contact with the support tape so as to leave on the support tape the labels recognised as compliant by the checking and control station, and wherein the main body is instead activatable in rotation about the respective rotation axis in a second rotation direction so as to arrange the two converging surfaces of the cusp of the second contact part in contact with the support tape so as to detach a label from the support tape which label has been recognised as non-compliant in the passage thereof from the checking and control station;
with the portion of cylindrical surface of the first contact part being arranged eccentric with respect to the rotation axis of the main body and with the first contact part and the second contact part of the contact portion being configured and conformed in such a way that, both when the main body is rotated about the respective rotation axis in order to arrange a part of the portion of cylindrical surface of the first contact part in contact with the support tape and when the main body is rotated about the respective rotation axis so as to arrange the two surfaces that are convergent to one another to form the cusp of the second contact part in contact with the support tape, the support tape winds about a part of the portion of cylindrical surface of the first contact part of the contact portion or on the two converging surfaces of the cusp of the second contact part always between a first contact point and a second contact point in such a way that the support tape maintains unaltered its predetermined unwinding path between the printing station and the advancement rollers of the support tape towards the label application station;
a detection and control unit of the position of the labels on the support tape arranged between the checking and control station and the first return roller; and
at least a second return member between the first return roller and the second return roller for defining the predetermined unwinding path of the support tape.

18. The apparatus as claimed in claim 17, wherein the second contact part of the contact portion comprises two flat surfaces which are convergent to one another in such a way as to form the cusp.

19. The apparatus as claimed in claim 17, further including guide means for guiding the non-compliant label detached from the support tape when the main body of the return member is activated in rotation about the respective rotation axis so as to arrange the two converging surfaces of the cusp of the second contact part in contact with the support tape, towards an accumulation and rejection station.

20. The apparatus as claimed in claim 17, wherein the second contact part of the contact portion is conformed in such a way as to form a triangular prism connected to the portion of cylindrical surface of the first contact part of the contact portion, and wherein the guide means comprise a drum having a rotation axis and arranged in a position facing the contact portion of the return member and an accumulation roller of non-compliant labels, which is mounted idle about a respective rotation axis and arranged in contact with the drum, wherein the drum, when the main body of the return member is activated in rotation about the respective rotation axis so as to arrange the two converging surfaces of the cusp of the second contact part in contact with the support tape so as to detach a non-compliant label from the support tape, is activatable in rotation about the respective rotation axis so as to abut at least an external part of the non-compliant label detached from the support tape and to guide the non-compliant label towards the accumulation roller in such a way that the part of the non-compliant label on which glue material is present abuts the accumulation roller and the non-compliant label attaches to the accumulation roller.
